(19) United States
(12) Patent Application Publication
(10) Pub. No.: US 2006/0176259 A1
(43) Pub. Date: Aug. 10, 2006

(54) Liquid crystal display device and display control method and program for the liquid crystal display device

(75) Inventor: Makoto Yamada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/348,484

(22) Filed: Feb. 7, 2006

(30) Foreign Application Priority Data
Feb. 8, 2005 (JP) P.2005-031549

(51) Int. Cl. G09G 3/36

(52) U.S. Cl. 345/88

(57) ABSTRACT

A display control method in a liquid crystal display device for displaying an image on a liquid crystal panel, comprising: fetching position information of a viewer relative to the liquid crystal panel; calculating a direction of the viewer's viewing the liquid crystal panel by using the position information; computing color reproducibility in the direction of the viewer's viewing the liquid crystal panel on the basis of the direction of the viewer's viewing the liquid crystal panel and color reproducibility data of the liquid crystal panel measured in viewing directions in advance; and correcting a color signal to display the image in accordance with the computed color reproducibility and displaying the image on the liquid crystal panel.

### FIELD OF THE INVENTION

The present invention relates to a liquid crystal display device capable of suppressing color variation in spite of change in viewing direction/angle with respect to a display screen, and a display control method and program for the liquid crystal display device.

### BACKGROUND OF THE INVENTION

Liquid crystal display devices have been widely used for PC monitors and home-use TV sets with the advance of image quality of the liquid crystal display in recent years. This type liquid crystal display device however has a typical problem that luminance variation or color variation occurs in dependence on the viewing angle. If there is such dependence on the viewing angle, the display color of a display image varies in accordance with the direction of the viewer's viewing the display screen of the liquid crystal display device.

Even if one and the same color is displayed, for example, the apparent color at the time of viewing the liquid crystal display device in an oblique direction is different from the display color at the time of viewing the liquid crystal display device in a just front direction. In a recent large-size display device with a large display screen, the apparent color varies according to the position on the display screen because the viewing angle varies according to the position on the display screen. There is a problem that the color displayed in the center portion of the display screen looks different from the color displayed in the peripheral portion of the display screen even if the color displayed in the center portion is the same as the color displayed in the peripheral portion.

As a countermeasure to this problem, there has been a report of development of a novel liquid crystal display method and use of an optically compensating film for improving viewing angle characteristic (e.g. “Liquid Crystal” Vo. 8, No. 2, pp 86 (2004)). However, change in luminance and change in color in accordance with the viewing angle has not been entirely suppressed yet, so that dependence on the viewing angle remains still.

### SUMMARY OF THE INVENTION

There is a great demand for viewing the display screen with normal color expression and normal luminance even if there is a limitation in setting of the liquid crystal display device, that is, even if the display screen cannot be viewed in a just front direction but can be viewed in an oblique direction. There is also a great demand for consistency in luminance and color on the whole display screen because there is a sense of incompatibility if luminance or color expression varies according to the position on the display screen at the time of viewing an image displayed on the display screen of a large-screen liquid crystal display device.

An object of the invention is to provide a liquid crystal display device in which consistency in luminance and apparent color can be obtained even if the direction of viewing a display screen changes, and a display control method and program for the liquid crystal display device.

The invention provides a display control method in a liquid crystal display device for displaying an image on a liquid crystal panel, including the steps of: fetching position information of a viewer relative to the liquid crystal panel; calculating a direction of the viewer's viewing the liquid crystal panel by using the position information; computing color reproducibility in the direction of the viewer's viewing the liquid crystal panel on the basis of the direction of the viewer's viewing the liquid crystal panel and color reproducibility data of the liquid crystal panel measured in viewing directions in advance; and correcting a color signal to display the image in accordance with the computed color reproducibility and displaying the image on the liquid crystal panel.

The color reproducibility data used in the display control method in a liquid crystal display device according to the invention are measured by a device for two-dimensionally measuring colors displayed on the liquid crystal panel.

The viewer position information used in the display control method in a liquid crystal display device according to the invention is acquired by a sensing means provided in the liquid crystal display device.

The invention provides a display control program for a liquid crystal display device wherein a display control method defined above is executed by a computer.

The invention provides a liquid crystal display device for displaying an image on a liquid crystal panel, including: an input means for fetching position information of a viewer relative to the liquid crystal panel; a means for calculating a direction of the viewer's viewing the liquid crystal panel on the basis of the position information and color reproducibility data of the liquid crystal panel measured in viewing directions in advance; and a means for computing color reproducibility in the direction of the viewer's viewing the liquid crystal panel on the basis of the viewing direction calculated by the previous means and the color reproducibility data, correcting a color signal to display the image and displaying the image on the liquid crystal panel in accordance with the computed color reproducibility.

The liquid crystal display device according to the invention further includes a sensing means for acquiring the position information of the viewer.

The invention provides a color reproduction method including the steps of: measuring color reproducibility data of a liquid crystal panel in viewing directions in advance when an image is to be displayed on the liquid crystal panel; acquiring information of a direction of the viewer's viewing the liquid crystal panel; calculating color reproducibility of the liquid crystal panel in the viewing direction on the basis of the color reproducibility data; and deciding a color signal to be displayed in accordance with the calculated color reproducibility and displaying the image on the liquid crystal panel.

According to the invention, the same image without color change can be watched regardless of the viewing direction when a liquid crystal display device is viewed.

### BRIEF DESCRIPTION OF THE DRAWINGS

FIGS. 1A and 1B are views for explaining a viewing direction in a liquid crystal display device according to an embodiment of the invention.

FIG. 2 is a diagram showing a system configuration for carrying out a display control method used in the liquid crystal display device according to the embodiment of the invention.

FIG. 3 is a flow chart showing a processing procedure of a display control program used in the liquid crystal display device according to the embodiment of the invention.

FIGS. 4A and 4B are views for explaining a viewing direction in a liquid crystal display device.

### DESCRIPTION OF REFERENCE NUMERALS

10: liquid crystal display device
11: liquid crystal panel (display screen)
12: Input Interface
13: display controller
20: personal computer
21: CPU
25: I/O interface portion

### DETAILED DESCRIPTION OF THE INVENTION

An embodiment of the invention will be described below with reference to the drawings.

For achievement of a display control method for a liquid crystal display device according to this embodiment, it is first necessary to measure display characteristic depending on the viewing direction of the liquid crystal display device.

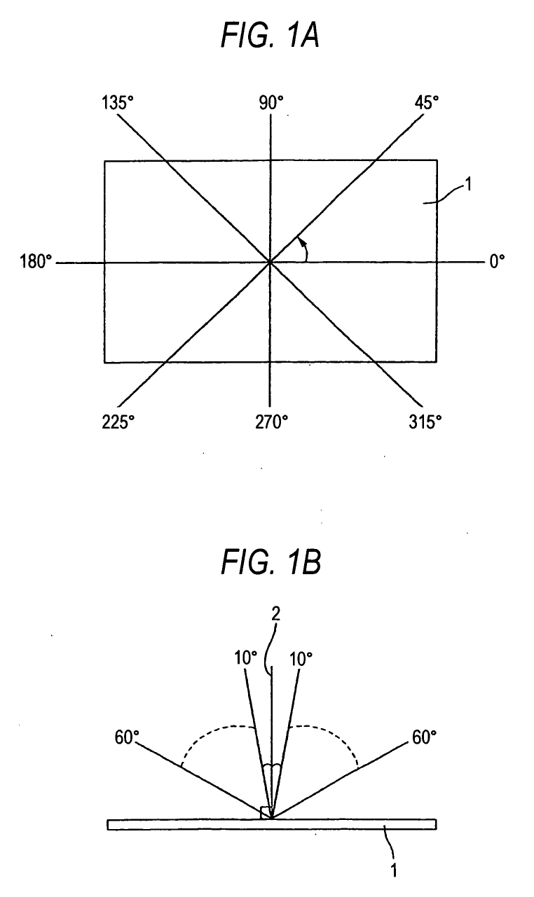

In this example, viewing directions are measured in eight steps concerned with azimuths 0°, 45°, 90°, . . ., 315° at intervals of 45° on a display screen 1 of the liquid crystal display device as shown in FIG. 1A and in seven steps concerned with polar angles 0°, 10°, . . . , 60° (angles relative to a perpendicular 2 drawn from the display screen 1) relative to the display screen 1 at intervals of 10° as shown in FIG. 1B, that is, the number of viewing directions to be measured is 8×7=56 in total.

There are measured XYZ tristimulus values (X_{R}, Y_{R}, Z_{R}, X_{G}, Y_{G}, Z_{G}, X_{B}, Y_{B} and Z_{B}) in the 56 viewing directions at emission of light of each of primary colors R (red), G (green) and B (blue) with maximum intensity in the center of the display screen 1 and relations (f_{R}[r], f_{G}[g], f_{B}[b]: the luminance value is normalized with the maximum value in each color) of the luminance value to the input signal at stepwise change in intensity of light of each of the primary colors in accordance with the 56 viewing directions. Incidentally, color measurement can be simplified when a device capable of acquiring colors two-dimensionally is used as a color measuring device. In this embodiment, color measurement is performed by a spectral radiance meter SR-3 made by Topcon Corp.

Data obtained by color measurement in accordance with the viewing direction are used for performing display control which will be described later. The measured data can be applied to the same kind of liquid crystal display devices but cannot be applied to any different kind of liquid crystal display devices. For example, measured data for 17-inch liquid crystal display devices made by Company A. cannot be applied to 17-inch liquid crystal display devices made by Company B. Accordingly, when a distributor distributes a display program for liquid crystal display devices to general users so that display control which will be described later can be performed, it is necessary to execute color measurement in accordance with each kind of liquid crystal display devices and store measured data in the program before the distributor distributes the display program.

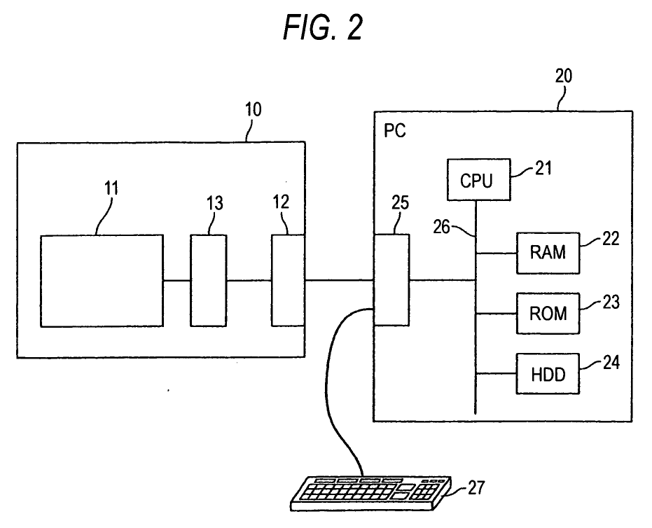

FIG. 2 is a configuration diagram of a personal computer system which executes a display control method for the liquid crystal display device according to the embodiment of the invention. A personal computer 20 is connected to the liquid crystal display device 10.

The liquid crystal display device 10 includes a liquid crystal panel 11 for forming a display screen, an input interface portion 12 for fetching a signal outputted from the personal computer 20, and a display control portion 13 for performing control so that the image signal fetched by the input interface portion 12 is displayed on the liquid crystal panel 11.

The personal computer 20 includes a CPU 21, an RAM 22, an ROM 23, a hard disk 24, an I/O interface portion 25, and a bus 26 for connecting these parts to one another. In the example shown in FIG. 2, the liquid crystal display device 10 is connected to a monitor output terminal of the I/O interface portion 25 while an input device such as a keyboard 27 or a pointing device not shown is connected to the I/O interface portion 25.

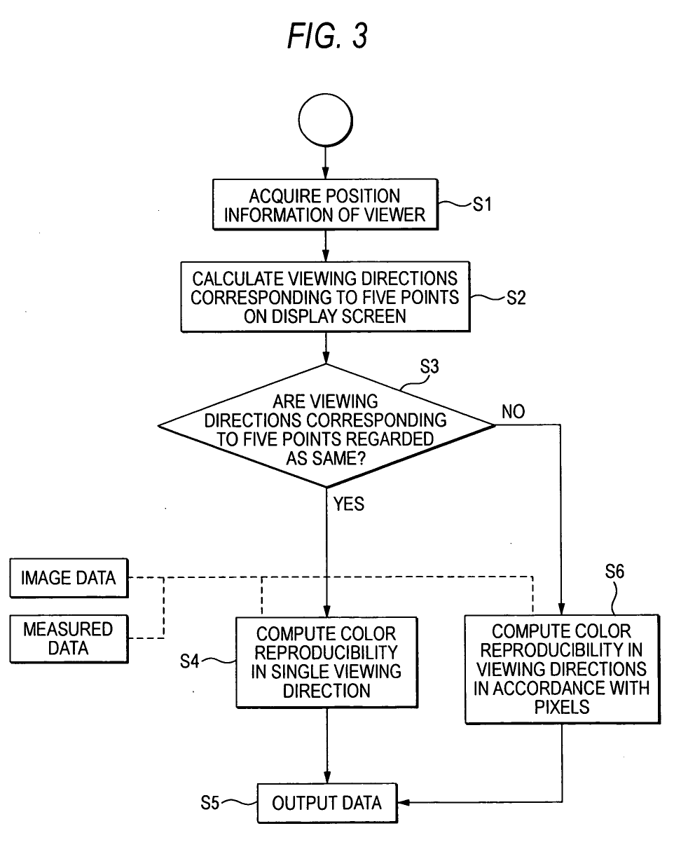

FIG. 3 is a flow chart showing a processing procedure of the display control program of the liquid crystal display device read in the hard disk 24 of the personal computer 20 depicted in FIG. 2.

The display control program is executed by the CPU 21 through an instruction inputted by the user.

When the display control program is started, position information of a viewer is first fetched in the CPU 21 in step S₁. The viewer position information may be given in such a manner that the user (viewer) inputs the user's position (relative to the liquid crystal display device 10) as numerical data by using the keyboard 21. Alternatively, the viewer position information may be given in such a manner that the user designates the user's position by using a pointing device on the display screen 11 in the condition that an image of the liquid crystal display device 10 is three-dimensionally displayed on the display screen 11 of the liquid crystal display device 10. Alternatively, the viewer position information may be given in such a manner that the viewer position relative to the liquid crystal display device 10 is calculated by the CPU 21 on the basis of the viewer's image fetched in the CPU 21 by a CCD camera (sensing means) which is connected to the I/O interface portion 25 of the personal computer 20 and which is set up in a predetermined place of the liquid crystal display device 10.

Then, in step S2, the CPU 21 computes a direction of the viewer's viewing the display screen 11 of the liquid crystal display device 10 on the basis of the viewer position relative to the liquid crystal display device 10. For example, the CPU 21 calculates a viewing direction in the case where the viewer views the center point of the display screen 11, and viewing directions in the case where the viewer views the four corners of the display screen 11. The calculation can be performed easily using geometry because the size of the display screen 11 is known.

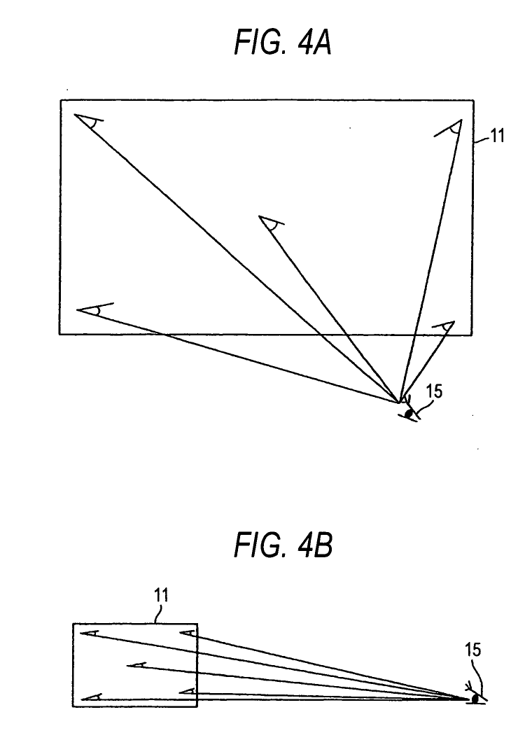

Then, in step S3, the CPU 21 judges whether the viewing directions corresponding to the five points (center and four corners) are largely displaced from one another or not. When, for example, the viewer 15 is near a large-size display screen 11 as shown in FIG. 4A, the viewing directions corresponding to the five points are largely different from one another. Accordingly, in this case, the apparent color in the center position of the display screen 11 is different from the apparent color in the peripheral portion of the display screen 11.

On the contrary, when the viewer gets a distant view of a small-size display screen 11 as shown in FIG. 4B, the viewing directions corresponding to the five points are little displaced from one another so that values of the displacement are in a predetermined range. In this case, the apparent color in the center portion of the display screen 11 is made equal to the apparent color in the peripheral portion of the display screen 11, except that the apparent color in the oblique direction is different from the apparent color in the just front direction.

When the judgment in step S3 makes a decision that the vales of displacement in the viewing directions corresponding to the five points are in the predetermined range, the situation of this routine goes to step S4 which is a process for calculating color reproducibility in a single viewing direction. In the color reproducibility calculation process, color reproducibility is calculated in the condition that the viewing direction corresponding to the center position of the display screen 11 is regarded as the single viewing direction applied to the whole display screen 11.

In the color reproducibility calculation process (step S4), R, G and B signals in each pixel on the display screen 11 are calculated on the basis of image data X, Y and Z to be displayed on the display screen 11 and the aforementioned measured data. This calculation is performed in accordance with the following expressions 1, 2 and 3.

$$\begin{matrix}( \begin{matrix}r \\ g \\ b\end{matrix} ) = {A}^{- 1} \cdot ( \begin{matrix}X \\ Y \\ Z\end{matrix} ) & [ Numeral 1 ] \\ R = 255 \cdot {f}_{R}^{- 1} [ r ] \\ G = 255 \cdot {f}_{G}^{- 1} [ g ] \\ B = 255 \cdot {f}_{B}^{- 1} [ b ] & [ Numeral 2 ] \\ A = ( \begin{matrix}{X}_{R} & {Y}_{R} & {Z}_{R} \\ {X}_{G} & {Y}_{G} & {Z}_{G} \\ {X}_{B} & {X}_{B} & {Z}_{B}\end{matrix} ) & [ Numeral 3 ]\end{matrix}$$

A matrix A in the expression 3 is equal to a formula based on the measured color data. In the aforementioned example, measured color data in a viewing direction closest to the single viewing direction are selected from the measured color data in 56 viewing directions. Alternatively, measured color data in the single viewing direction may be calculated by interpolation of measured color data in 56 viewing directions.

On the basis of the expression 1, r, g and b signals are calculated. The r, g and b signals are substituted into the relation (f_{R}[r], f_{G}[g] and f_{B}[b]) to the measured luminance values, so that R, G and B signals are calculated in accordance with the expression 2. Also in this case, the relation of luminance values to the single viewing direction is used. In the next step S5, the calculated R, G and B signals are outputted to the liquid crystal display device 10.

As a result, the viewer in the state shown in FIG. 4B, that is, the viewer getting a distant view of the liquid crystal panel 11 in an oblique direction can watch the image in the same state as that in which the liquid crystal panel 11 is viewed in the just front direction. If the image data X, Y and Z are displayed on the liquid crystal panel 11 directly without such calculation of color reproducibility, the color grows faint on the whole display screen 11 because the viewer views the display screen 11 obliquely. In this embodiment, a sharp color image can be watched even in the case where the display screen 11 is viewed obliquely.

When the judgment in step S3 makes a decision that the viewing directions corresponding to the five points are largely displaced from one another, the situation of this routine goes from step S3 to step S6 to calculate color reproducibility in accordance with pixels. That is, in this case, viewing directions are calculated in accordance with pixels of the display screen, so that R, G and B signals in each pixel are calculated on the basis of the expressions 1, 2 and 3 and outputted to the liquid crystal display device 10 (step S5).

As a result, the viewer in the state shown in FIG. 4A, that is, the viewer getting a near view of the large-size liquid crystal display device 10 can watch the image in the condition that the apparent color in the center portion of the display screen is the same as the apparent color in the peripheral portion of the display screen. Particularly because a recent thin large-size TV set can be connected to the personal computer so that it can be used as a monitor screen, improvement in display quality of the display screen in the case where a large-size liquid crystal display device 10 such as a 32-inch display device or a 50-inch display device is used as a monitor screen can be attained when the display control method according to this embodiment is applied to the large-size liquid crystal display device 10.

Although the embodiment has been described on the case where the judgment in step S3 separates the result into two cases, that is, the case where the single viewing direction is applied to the whole display screen and the case where viewing directions are calculated in accordance with pixels, color reproducibility may be calculated in the intermediate case where, for example, the display screen is separated into 10×10 regions so that viewing directions are calculated in accordance with the regions.

Although the embodiment has been described on the case where the personal computer 20 executes a color reproduction process to display the image on the liquid crystal display device 10, it is a matter of course that the display controller 13 in the liquid crystal display device 10 may be formed to have a computer function so that the display control program shown in FIG. 3 can be executed by the computer function. Although the embodiment has been described on the case where the personal computer executes a color reproducibility calculation process for image data to be displayed on the monitor screen, the same color reproducibility calculation process may be performed for an image outputted from a tuner, that is, for a TV video signal so that the resulting image is displayed on the display screen 11.

In the display control method for a liquid crystal display device according to the invention, the same color as in the case where the display device is viewed in a just front direction can be displayed even in the case where the direction of viewing the liquid crystal display device is oblique. Accordingly, the liquid crystal display device is useful as a display device high in image display quality.

This application is based on Japanese Patent application JP 2005-31549, filed Feb. 8, 2005, the entire content of which is hereby incorporated by reference, the same as if set forth at length.

[FIG. 3]

S1: Acquire position information of a viewer.
S2: Calculate viewing directions corresponding to five points on a display screen.
S3: Are the viewing directions corresponding to five points regarded as the same?
S4: Compute color reproducibility in a single viewing direction.
S5: Output data.
S6: Compute color reproducibility in viewing directions in accordance with pixels.

What is claimed is:

1. A display control method in a liquid crystal display device for displaying an image on a liquid crystal panel, comprising:
fetching position information of a viewer relative to the liquid crystal panel;
calculating a direction of the viewer's viewing the liquid crystal panel by using the position information;
computing color reproducibility in the direction of the viewer's viewing the liquid crystal panel on the basis of the direction of the viewer's viewing the liquid crystal panel and color reproducibility data of the liquid crystal panel measured in viewing directions in advance; and
correcting a color signal to display the image in accordance with the computed color reproducibility and displaying the image on the liquid crystal panel.

2. The display control method according to claim 1, wherein the color reproducibility data are measured by a device for two-dimensionally measuring colors displayed on the liquid crystal display panel.

3. The display control method according to claim 1, wherein the viewer position information is acquired by a sensing means provided in the liquid crystal display device.

4. A display control program for a liquid crystal display device wherein a display control method defined in claim 1 is executed by a computer.

5. A liquid crystal display device for displaying an image on a liquid crystal panel, comprising:
an input means for fetching position information of a viewer relative to the liquid crystal panel;
a means for calculating a direction of the viewer's viewing the liquid crystal panel on the basis of the position information and color reproducibility data of the liquid crystal panel measured in viewing directions in advance; and
a means for computing color reproducibility in the direction of the viewer's viewing the liquid crystal panel on the basis of the viewing direction calculated by the previous means and the color reproducibility data, correcting a color signal to display the image and displaying the image on the liquid crystal panel in accordance with the computed color reproducibility.

6. The liquid crystal display device according to claim 5, further comprising a sensing means for acquiring the position information of the viewer.

7. A color reproduction method comprising:
measuring color reproducibility data of a liquid crystal panel in viewing directions in advance when an image is to be displayed on the liquid crystal panel;
acquiring information of a direction of the viewer's viewing the liquid crystal panel;
calculating color reproducibility of the liquid crystal panel in the viewing direction on the basis of the color reproducibility data; and
deciding a color signal to be displayed in accordance with the calculated color reproducibility and displaying the image on the liquid crystal panel.
